(19) United States
(12) Patent Application Publication
(10) Pub. No.: US 2025/0175945 A1
(43) Pub. Date: May 29, 2025

(54) PAGING ALERT DESIGN FOR NON-TERRESTRIAL NETWORKS (NTNS)

(71) Applicant: Apple Inc., Cupertino, CA (US)

(72) Inventors: Chunxuan YE, San Diego, CA (US); Dawei ZHANG, Saratoga, CA (US); Haitong SUN, Cupertino, CA (US); Wei ZENG, Saratoga, CA (US); Hong HE, San Jose, CA (US); Jie CUI, San Jose, CA (US); Sigen YE, San Diego, CA (US); Chunhai YAO, Beijing (CN)

(73) Assignee: Apple Inc., Cupertino, CA (US)

(21) Appl. No.: 18/885,847

(22) Filed: Sep. 16, 2024

Related U.S. Application Data
(60) Provisional application No. 63/603,723, filed on Nov. 29, 2023.

(51) Int. Cl. H04W 68/02; H04B 17/318

(52) U.S. Cl. CPC H04W 68/02; H04B 17/328

(57) ABSTRACT

Aspects are described for a user equipment (UE) comprising a transceiver configured to enable wireless communication with a base station and a processor communicatively coupled to the transceiver. The processor is configured to receive a paging alert (PA) from the base station. The processor is further configured to generate a notification for a user of the UE to physically move the UE based on the PA and receive a paging message from the base station based on the PA.

### CROSS REFERENCES

This application claims the benefit of U.S. Provisional Application No. 63/603,723 filed Nov. 29, 2023, titled “Paging Alert Design for Non-Terrestrial Networks (NTNs),” the content of which is herein incorporated by reference in its entirety.

### BACKGROUND

### Field

The described aspects generally relate to a paging alert design for a user equipment (UE) operating in a non-terrestrial network (NTN) for wireless communications.

### SUMMARY

Some aspects of this disclosure relate to systems, apparatuses, and methods for implementing to a paging alert design for a UE operating in an NTN for wireless communications. For example, the systems, the apparatuses, and the methods are provided for notifying a user of the UE to move the UE to prepare for receiving a paging message.

Some aspects of this disclosure relate to a UE comprising a transceiver configured to enable wireless communication with a base station and a processor communicatively coupled to the transceiver. The processor is configured to receive a paging alert (PA) from the base station. The processor is further configured to generate a notification for a user of the UE to physically move the UE based on the PA and receive a paging message from the base station based on the PA.

Some aspects of this disclosure relate to a method of operating a UE. The method comprises receiving a PA from a base station. The method further comprises generating a notification for a user of the UE to physically move the UE based on the PA and receiving a paging message from the base station based on the PA.

Some aspects of this disclosure relate to a base station comprising a transceiver configured to enable wireless communication with a UE and a processor communicatively coupled to the transceiver. The processor is configured to generate a PA that triggers the UE to generate a notification to physically move the UE. The processor is further configured to transmit the PA to the UE and transmit a paging message based on the PA.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing a paging alert in an NTN wireless network, according to some aspects of the disclosure.

FIG. 2 illustrates a block diagram of an example system of an electronic device for implementing a paging alert, according to some aspects of the disclosure.

FIG. 3 illustrates an example of a paging alert, according to aspects of the disclosure.

FIG. 4 illustrates an example method of a UE operating based on a paging alert, according to aspects of the disclosure.

FIG. 5 illustrates an example method of a UE operating based on a short message, according to aspects of the disclosure.

FIG. 6 illustrates an example method of a UE operating using a paging alert, according to aspects of the disclosure.

FIG. 7 illustrates an example method of a base station operating using a paging alert, according to aspects of the disclosure.

FIG. 8 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for implementing to a paging alert design for a UE operating in an NTN for wireless communications. For example, the systems, the apparatuses, and the methods are provided for notifying a user of the UE to physically move the UE to prepare for receiving a paging message.

In some aspects, a UE is powered by batteries and thus has limited energy without being charged. One way to reduce energy consumption is to enter into a power saving mode or a sleep mode when no data transmission or little data transmission is expected. For example, the UE can enter into a sleep mode for a period when no phone call is expected during the period. In some aspects, data transmission includes phone calls. The UE consumes much less energy in the sleep mode. When an incoming phone call is scheduled, a base station serving the UE or monitoring the UE can send a paging message to the UE and the UE can wake up and prepare to receive the phone call upon receiving the paging message. In some aspects, the UE is configured with one or more paging occasions and receives the paging message in at least one of the one or more paging occasions. The one or more paging occasions are periods in time when the paging message may be received. Thus, the UE can wake up during each of the one or more paging occasions to attempt to receive the paging message. If the paging message is received during a paging occasion, the UE can wake up based on the paging message. For example, the UE can stay awake to receive further communications, such as phone calls and/or data transmissions. For another example, the UE can go back to the sleep mode and wake up again later to receive the further communications. If the paging message is not received during the paging occasion, the UE can go back to the sleep mode and wake up again during a next paging occasion. In such a case, the UE saves energy by staying in the sleep mode outside the one or more paging occasions.

In some aspects, to receive the paging message, the UE may need to maintain synchronization with the base station. For example, the UE needs to maintain synchronization with the base station to know when the one or more paging occasions come and to receive the paging message in at least one of the one or more paging occasions. In some aspects, the UE can keep synchronization by receiving synchronization signal block (SSB) signals from the base station. For example, the UE may need to wake up periodically to receive the SSB signals so that the UE is synchronized with the base station. For another example, the UE may not need to fully wake up to receive the SSB signals. Specifically, the UE may be equipped with a main transceiver and a secondary transceiver. The secondary transceiver can consume less energy than the main transceiver. In such a case, the UE can use the secondary transceiver to receive the SSB signals and thus to save energy.

In some aspects, the base station can transmit a paging early indication (PEI) to the UE to indicate whether a paging message is to be transmitted in a next paging occasion. For example, the base station can transmit the PEI following an SSB signal. When the PEI indicates that a paging message is to be transmitted during the next paging occasion, the UE can keep receiving the SSB signals and being synchronized with the base station. Otherwise, when the PEI indicates that no paging message is to be transmitted during the next paging occasion, the UE can ignore the SSB signals until the next paging occasion. In such a case, the UE saves energy by not receiving the SSB signals when no paging message is expected.

In some aspects, the UE may be served by an NTN wireless communication network. For example, the UE may connect with the base station via a satellite. In some aspects, the satellite assigns a tight link budget to the UE. For example, the UE may not be able to receive signals from the satellite when the UE is placed in a pocket or a backpack or the UE is in a location where a line-of-sight (LoS) to the satellite is blocked. Thus, the UE may not be able to receive a paging message or a phone call following the paging message from time to time. In some aspects, the base station can transmit, via the satellite, a paging alert (PA) to the UE to trigger a notification to a user of the UE. The base station can transmit the PA with a higher link budget compared with other signals (e.g, PEI) transmitted to the UE. For example, the PA can be transmitted with a higher power so that the PA is received with a higher received signal power or a higher signal-to-noise ratio (SNR). For another example, the PA can be transmitted with a lower order of modulation and/or lower coding rate so that signals carrying the PA is more robust. In either case, the UE may be able to receive the PA even when the UE is placed in a pocket or in a position with no LoS to the satellite. The base station may transmit the PA to replace the PEI or in addition to the PEI. In some aspects, the PA can indicate to the UE to be prepared to receive the paging messaging that is upcoming. In some aspects, the notification can indicate to the user to physically move the UE for a better signal reception. For example, the UE can determine that a signal strength of received signals from the base station is too low to detect and receive the paging message and thus generate the notification for the user. The notification can cause the user to take out the UE from the pocket or the backpack. The notification can also cause the user to physically move the UE to a higher ground so that the LoS is available. In some aspects, the notification can indicate that the signal strength is too low and actions are needed. In other aspects, the notification can indicate that the UE needs to be physically moved to a different location for a better signal reception. In either case, the notification can at least cause the user to take out the UE from the pocket or the backpack to check the notification. The notification can be a sound, a series of vibrations, and/or a text message. After the user physically moves the UE, the UE can receive following paging messages and wake up to receive further communications.

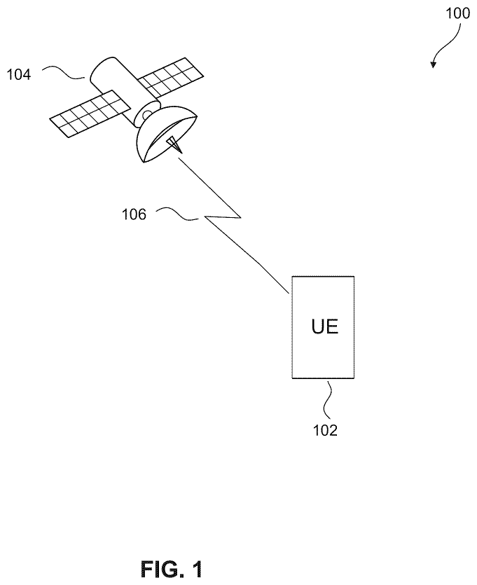

FIG. 1 illustrates an example system 100 implementing a paging alert in an NTN wireless network, according to some aspects of the disclosure. The example system 100 is provided for the purpose of illustration only and does not limit the disclosed aspects. The example system 100 may include, but is not limited to, a UE 102 and a base station 104. At least a portion of the base station 104 is implemented as a satellite, as shown in FIG. 1. Additionally, in embodiments, base station 104 may also include a ground station (not shown) to enable communications to a backhaul network. The UE 102 may be implemented as electronic devices configured to operate based on a wide variety of wireless communication techniques. These techniques may include, but are not limited to, techniques based on 3rd Generation Partnership Project (3GPP) standards. For example, the UE 102 can be configured to operate using one or more 3GPP releases, such as Release 15 (Rel-15), Release 16 (Rel-16), Release 17 (Rel-17), Release 18 (Rel-18), and/or other 3GPP releases. The UE 102 may include, but is not limited to, wireless communication devices, smartphones, laptops, desktops, tablets, personal assistants, monitors, televisions, wearable devices, Internet of Things (IoT) devices, vehicle communication devices, and the like. The base station 104 may include one or more nodes configured to operate based on a wide variety of wireless communication techniques such as, but not limited to, techniques based on the 3GPP standards. For example, the base station 104 may include nodes configured to operate using Rel-15, Rel-16, Rel-17, Rel-18, or other 3GPP releases. The base station 104 may include, but not limited to, satellites, high altitude platforms (HAPs) such as hot air balloons, air-borne base stations, unmanned aerial vehicles (UAVs), NodeBs, eNodeBs, gNBs, new radio base stations (NR BSs), access points (APs), remote radio heads, relay stations, and others.

In some aspects, the UE 102 connects with the base station 104 via a communication link 106. The communication link 106 can include uplink (UL) connections and downlink (DL) connections. In some aspects, the UE 102 can enter into a sleep mode to save energy and wake up when communications from the base station 104 are expected. For example, the base station 104 can transmit a paging message to the UE 102 via the communication link 106. The paging message can indicate subsequent communications, such as phone calls and/or data transmissions. Thus, when the UE 102 receives the paging message, the UE 102 can wake up to receive the further communications via the communication link 106. In some aspects, the UE 102 can wake up in paging occasions to check whether a paging message is transmitted and to be received. In addition, the UE 102 may also need to wake up periodically to receive SSB signals to keep the UE 102 synchronized with the base station 104 so that the UE 102 can receive signals in the paging occasions.

In some aspects, to further save energy of receiving the SSB signals and checking the paging occasions when no paging message is to be transmitted by the base station 104, the base station 104 can transmit PEI to the UE 102 indicating whether a paging message is to be transmitted in a next paging occasion. When the PEI indicates that no paging message is to be transmitted in the next paging occasion, the UE 102 can further save energy by refraining from receiving the SSB signals and refraining from checking the next paging occasion.

In some aspects, the UE 102 is served by an NTN wireless network, such as the system 100. The base station 104 may assign a tight link budget to the UE 102 because the base station 104 has limited energy and serves a plurality of UEs including the UE 102. For example, the base station 104 may include a satellite that is powered by batteries that can be charged by solar panels. To transmit to each of the plurality of UEs, the satellite may need to form beams to point to each of the plurality of UEs, which consumes energy. Thus, the satellite may assign tight link budgets to each of the plurality of UEs including the UE 102. Therefore, the signal power for communication signals from the BS 104 may be reduced in order to save energy. In some aspects, the UE 102 may be placed in a pocket or a backpack. For example, a user of the UE 102 may travel in a mountain area and the user may place the UE 102 inside the pocket or the backpack to keep the UE 102 from being damaged. In addition, terrestrial networks provided by cellular towers may not be available in the mountain area and thus the UE 102 is connected to an NTN wireless network via the base station 104. However, since the link budget assigned to the UE 102 is tight, the UE 102 may not be able to receive signals from the base station 104 when placed in the pocket or the backpack. For example, signals carrying the paging message may be too weak for the UE 102 to decode because of signal degradations caused by the pocket or backpack. In such a case, the base station 104 can transmit a paging alert to the UE 102 prior to transmitting the paging message so that the UE 102 can notify the user to physically move the UE 102 out of the pocket or the backpack. For example, the base station 104 can transmit the paging alert using a higher power so that the paging alert can penetrate the pocket or the backpack. For another example, the base station 104 can transmit the paging alert with a more robust modulation and coding configuration so that the UE 102 can recover and decode the paging alert with a weak signal strength. After receiving the paging alert, the UE can determine that the UE is in a position where a signal strength of received signals from the base station is too low to receive the paging message. In such a case, the UE can generate a notification to the user so that the user can physically move the UE to a different position to improve the signal strength. In some aspects, the notification can indicate that the signal strength is too low and actions are needed. In other aspects, the notification can indicate that the UE needs to be physically moved to a different location for a better signal reception. In either case, the notification can at least cause the user to take out the UE from the pocket or the backpack to check the notification. The notification can be a sound, a series of vibrations, and/or a text message. After the user physically moves the UE, the UE can receive following paging messages and wake up to receive further communications.

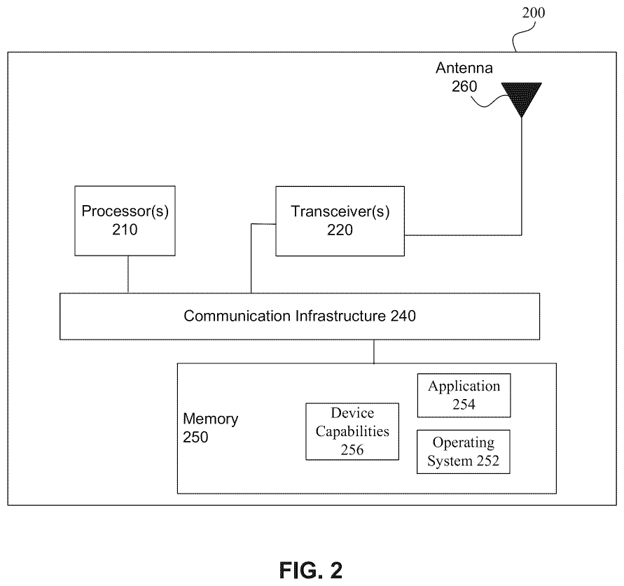

FIG. 2 illustrates a block diagram of an electronic device 200 implementing a paging alert, according to some aspects of the disclosure. The electronic device 200 may be any of the electronic devices (e.g., the UE 102 and the base station 104) of the system 100. The electronic device 200 includes a processor 210, transceivers 220, a communication infrastructure 240, a memory 250, an operating system 252, an application 254, device capabilities 256, and antennas 260. Illustrated systems are provided as exemplary parts of electronic device 200, and electronic device 200 may include other circuit(s) and subsystem(s). Also, although the systems of electronic device 200 are illustrated as separate components, the aspects of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. The applications in the application 254 may include applications such as, but not limited to, radio streaming, video streaming, remote control, and/or other user applications. In some aspects, the device capabilities 256 may be stored in the memory 250.

The electronic device 200 may also include the communication infrastructure 240. The communication infrastructure 240 provides communication between, for example, the processor 210, the transceivers 220, and the memory 250. In some implementations, the communication infrastructure 240 may be a bus.

The transceivers 220 transmit and receive communications signals include legacy reference signals and other data communication signals. Additionally, the transceivers 220 transmit and receive communications signals that support mechanisms for measuring communication link(s), generating and transmitting system information, and receiving the system information. According to some aspects, the transceivers 220 may be coupled to the antennas 260 to wirelessly transmit and receive the communication signals. The antennas 260 may include one or more antennas that may be the same or different types and can form one or more antenna ports. The transceivers 220 enable electronic device 200 to communicate with other devices that may be wired and/or wireless. In some examples, the transceivers 220 may include processors, controllers, radios, sockets, plugs, buffers, and like circuits/devices used for connecting to and communication on networks. According to some examples, the transceivers 220 include one or more circuits to connect to and communicate on wired and/or wireless networks.

Additionally, the transceivers 220 may include one or more circuits (including a cellular transceiver) for connecting to and communicating on cellular networks. The cellular networks may include, but are not limited to, 3G/4G/5G networks such as Universal Mobile Telecommunications System (UMTS), Long-Term Evolution (LTE), and the like. For example, the transceivers 220 may be configured to operate according to one or more of Rel-15, Rel-16, Rel-17, Rel-18, or other releases of 3GPP standard.

In addition, one or more transceivers can include one or more circuits for connecting to and communicating with satellite networks. Such satellite networks can include, but are not limited to, wireless communication networks such as 3G/4G/5G networks such as Universal Mobile Telecommunications System (UMTS), Long-Term Evolution (LTE), as well as specific satellite communications network protocols for gateway functionality and control functionality from satellite ground stations. For example, one or more transceivers 220 can be configured to operate according to one or more of Rel-15, Rel-16, Rel-17, Rel-18, or other of the 3GPP standard. In addition, for LEO-earth-fixed types of satellites, additional capability is provided to steer beams towards fixed points on the Earth's surface by either beamforming or by a mechanically steerable beam approach.

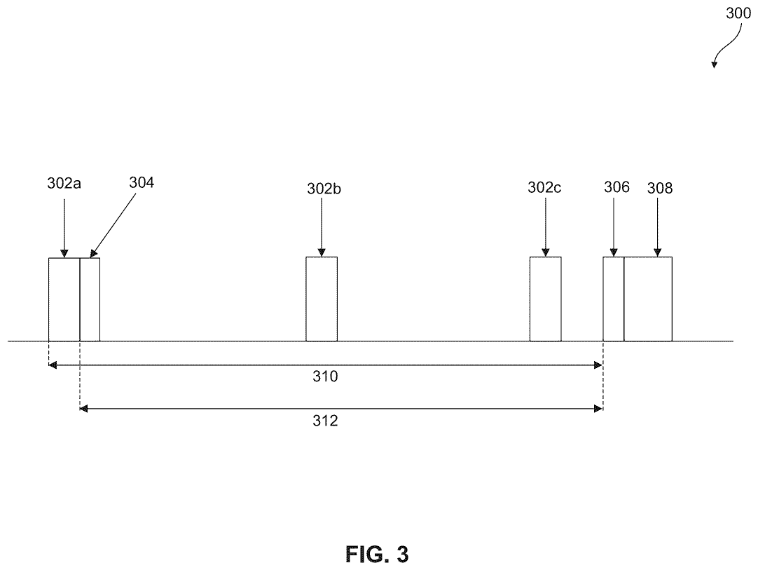

As discussed in more detail below with respect to FIGS. 3-8, processor 210 may implement different mechanisms for the paging alert as discussed with respect to the system 100 of FIG. 1. For example, in some embodiments, memory 250 can store instructions, that when executed by processor 210 cause processor 210 to perform or cause the electronic device 200, to perform operations described herein, e.g., operations to support a paging alert mechanism in an NTN wireless network. Alternatively, processor 210 can be “hard-coded” to perform, or cause to perform, the operations described herein. In some embodiments, processor 210 can be configured to perform, or cause to perform, the operations described in FIGS. 3-7.

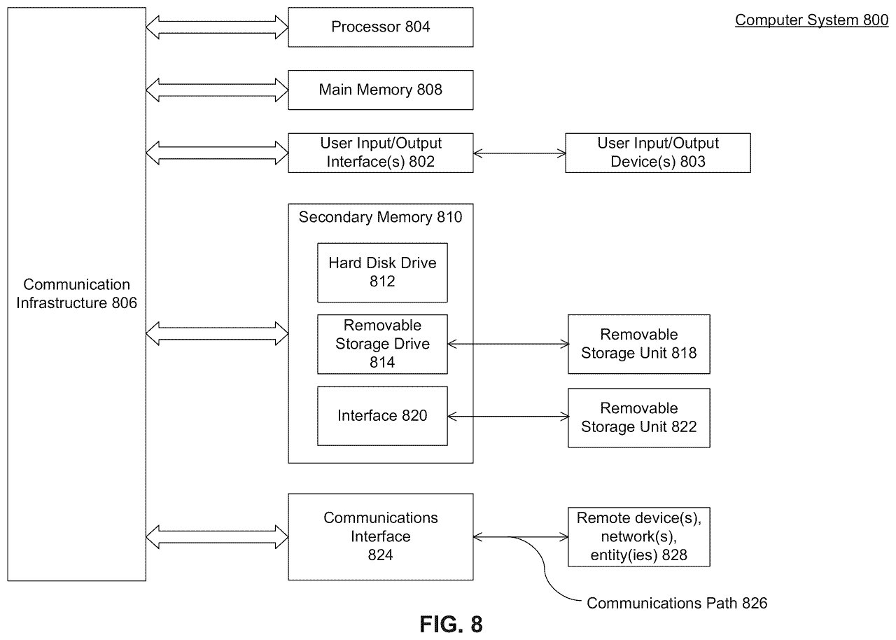

FIG. 3 illustrates an example 300 of a paging alert mechanism. The example method 300 is provided for the purpose of illustration only and does not limit the disclosed aspects. As a convenience and not a limitation, FIG. 3 may be described with regard to elements of FIGS. 1, 2, and 8. The example 300 may represent the operation of electronic devices (for example, the UE 102 and the base station 104 of FIG. 1) implementing the paging alert mechanism. The example 300 may also be performed by the electronic device 200 of FIG. 2, controlled or implemented by processor 210, and/or computer system 800 of FIG. 8. But the example method 300 is not limited to the specific aspects depicted in those figures and other systems may be used to perform the method, as will be understood by those skilled in the art. It is to be appreciated that not all operations may be needed, and the operations may not be performed in the same order as shown in FIG. 3.

In some aspects, the example 300 illustrates signals that can be received by a UE, such as the UE 102 of FIG. 1, from a base station, such as the base station 104 of FIG. 1 in a chronograph order from left to right. For example, the signals include SSB signals 302a, 302b, and 302c, paging signals 304, physical downlink control channel (PDCCH) signals 306, and physical data shared channel (PDSCH) signals 308. In some aspects, the paging signals 304 can comprise a PEI, a paging alert, or both. When the paging signals 304 include a PEI, the PEI indicates whether a paging message is to be received in a next paging occasion. For example, the next paging occasion can be a period when the PDSCH signals 308 are received. When the PEI indicates that the paging message is to be received in the PDSCH signals 308, the UE 102 can detect and receive information regarding the paging message in the PDCCH signals 306. In some aspects, the information includes a time location of the paging message within the PDSCH signals 308. The information can also include a decoding configuration for the paging message, such as modulation configuration, coding configuration, and other configurations of the paging message, to enable the UE to decode the paging message. In some aspects, the paging message can indicate further communications from the base station, such as phone calls and further data transmissions. The UE can wake up based on the paging message to receive the further communications.

In some aspects, the PEI can indicate a group of UEs for which the PEI is intended. For example, the PEI may include a group indicator that corresponds to a group of UEs including the UE. When the UE receives the PEI, it can determine whether the PEI includes the group indicator. If the group indicator is not included, the UE can determine that no paging message is to be received in the next PDSCH signal 308 and can return to the power saving mode or the sleep mode. If the UE determines that the PEI includes the group indicator, the UE can maintain synchronization by receiving the SSB signals 302b and 302c and receive the PDCCH signals 306. In such a case, the information included in the PDCCH signals 306 can indicate which UE of the group of UEs is to receive the paging message. For example, the information can indicate a UE identification (ID). If the UE ID corresponds to the UE, the UE can receive the PDSCH signals 308 and detect the paging message based on the information. Otherwise, the UE can return to the power saving mode or the sleep mode. When the UE is not the intended recipient of the paging message, the UE has exspended energy on receiving the SSB signals 302b and 302c to maintain synchronization when no paging message is to be received in the PDSCH signals 308. Therefore, the PEI may be a false alarm. In summary, when a UE of the group of UEs expects a paging message, other UEs of the group of the UEs may spend extra energy without having a paging message to receive. In some aspects, the PEI can indicate a subgroup of UEs with a smaller number of UEs compared with the group of UEs. In such a case, the UE is less likely to spend energy when no paging message is to be received.

In some aspects, the UE can maintain synchronization with the base station during a period 310 when a paging message is to be received. For example, the UE can synchronize its time with that of the base station based on the SSB signals 302a, 302b, and 302c. By receiving the SSB signal 302a, the UE can properly receive the paging signals 304. Furthermore, when the paging signals 304 includes the PEI that indicates an upcoming paging message in the PDSCH signals 308, the UE can maintain synchronization by receiving the SSB signals 302b and 302c to properly receive the information regarding the paging message in the PDCCH signals 306 and then the paging message in the PDSCH signals 308. In some aspects, the UE is configured with a period 312, which indicates a time gap between a first frame of the paging signals 304 and a first frame of the PDCCH signals 306. In such a case, the UE is aware of time locations of the PDCCH signals 306 when the UE is synchronized. The period 312 can also be referred to as a frame offset and is configured based on a number of frames. For example, the period 312 can be configured up to be up to 16 frames, such as 160 ms. In other aspects, when the PEI indicates that no paging message is to be received in following PDSCH signals, such as the PDSCH signals 308, the UE can refrain from performing synchronization and does not need to receive at least the SSB signals 302b and 302c. In such a case, the UE can save energy that would otherwise be used to detect and receive the SSB signals and to perform synchronization during the period 312.

In some aspects, the paging signals 304 can include a paging alert instead of the PEI. The paging alert can similarly indicate whether a paging message in the PDSCH 308 is to be received. In addition, the paging alert can trigger the UE to notify a user of the UE to physically move the UE. For example, the UE may operate in an NTN wireless network and the base station communicates with the UE via a satellite. In such a case, the UE may be assigned a tight link budget and any further degradation of signals besides a path loss may make the signals undetectable to the UE. For example, the UE may be placed in a pocket or a backpack when a signal is transmitted to the UE. Signals transmitted by the satellite, after experiencing the path loss, that are otherwise detectable can be further degraded by the pocket or the backpack and become undetectable to the UE. The signals can include the PDCCH signals 306 and the PDSCH signals 308. In such a case, the UE may not be able to receive the paging message and thus cannot wake up to receive the further communications as discussed above. To solve this problem, the paging alert can trigger the UE to notify the user of the UE to physically move the UE. For example, the paging signals 304 that include the paging alert can be transmitted using a higher power and/or using a more robust modulation and coding schemes compared with the PDCCH signals 306 and the PDSCH signals 308. Thus, the UE can still receive the paging signals 304 even when the UE is placed inside a pocket or a backpack. When the UE receives the paging alert included in the paging signals 304 and the paging alert indicates that a paging message is to be received in the PDSCH signals 308, the UE can notify the user of the UE to physically move the UE, e.g. outside of the pocket or the backpack so that the UE can receive the PDCCH signals 306 and the PDSCH signals 308 to retrieve the paging message. For example, after receiving the paging alert, the UE can determine that the UE is in a position where a signal strength of received signals from the base station is too low to receive the paging message. In such a case, the UE can generate a notification to the user so that the user can physically move the UE to a different position to improve the signal strength. In some aspects, the notification can indicate that the signal strength is too low and actions are needed. In other aspects, the notification can indicate that the UE needs to be physically moved to a different location for a better signal reception. In either case, the notification can at least cause the user to take out the UE from the pocket or the backpack to check the notification. In some aspects, the notification can be a sound, a series of vibrations, and/or a text message.

In some aspects, the PDCCH signals 306 can be repeatedly transmitted prior to the PDSCH signals 308. For example, the base station can transmit the PDCCH signals 306 periodically for N times. In such a case, the UE is more likely to detect the information regarding the paging message in at least one of the N transmissions. For example, as mentioned above, the UE may be assigned the tight link budget and thus the UE may fail to receive one or more of the N transmissions of the PDCCH signals 306. However, if the UE can receive at least one of the N transmissions of the PDCCH signals 306, the UE is able to use the information to receive the paging message carried in the PDSCH signals 308. Furthermore, the base station can also repeatedly transmit the paging alert. For example, the UE may be in an area where receiving signals are weak and the UE may fail to detect a paging alert. In such a case, the UE can request the base station to transmit the paging alert repeatedly so that the UE can detect the paging alert.

In some aspects, when the paging signals 304 includes the paging alert, the period 312 is larger than that when the paging signals 304 includes the PEI. For example, as discussed above, the period 312 can be up to 16 frames or 160 ms. Thus, the UE has up to 160 ms to prepare for receiving the PDCCH signals 306 when the paging signals 304 include the PEI. However, when the paging signals 304 include the paging alert, the UE needs more time. This is because the paging alert may enable the UE to notify the user of the UE to physically move the UE. For example, the UE may be placed in a pocket or a backpack. In such a case, the period 312 needs to be long enough for the user to find and physically move the UE, which can be a couple of seconds. For another example, the UE may be in a position where a LoS to the satellite is blocked by trees or other obstacles. Thus, the user may need to physically move to a new position with no tree leaves above or on a top of a hill. In such a case, the user may need couple of minutes to move the UE to the new position. In some aspects, the base station can configure the UE with the period 312. In addition, the UE can report a length of the period 312 to the base station and the base station can grant or adjust the reported length.

In some aspects, the paging alert can configured in addition to the PEI instead of in place of the PEI. For example, the base station may transmit one or more repeated paging alerts following the PEI. In such a case, the UE may receive both the PEI and the one or more paging alerts. As discussed above, the period 312 may be configured differently for the PEI and the paging alert. Thus, the PEI and the paging alerts may correspond to their respective PDCCH signals 306. For example, the PEI may correspond to PDCCH signals 306 to be received 100 ms after the PEI is received. Thus, the UE can check and receive the information regarding the paging message in the PDCCH signals 306 100 ms after the PEI is received. If the PEI indicates that no paging message is to be received, the UE does not return to the power saving mode or the sleep mode immediately. Instead, the UE continues to receive the one or more paging alerts. The one or more paging alerts may correspond to PDCCH signals 306 to be received 10 seconds after the one or more paging alerts are received. If the one or more paging alerts indicate that the paging message is to be receive, the UE triggers the notification to the user to physically move the UE and maintains synchronization to receive the PDCCH signals 306 after 10 seconds. Otherwise, if the one or more paging alerts indicate no paging message to be received, the UE returns to the power saving mode or the sleep mode. In summary, when both the PEI and the paging alert are configured, the UE may check both before returning to the power saving mode or the sleep mode.

In some aspects, the base station can transmit more than one paging message to the UE in a long duration, such as 10 seconds. For example, in case the base station configures the UE with a PEI and one or more paging alerts as discussed above, the base station can transmit a first paging message corresponding to the PEI and a second paging message corresponding to the one or more paging alerts. The UE can receive the first paging message based on the PEI and can also receive the second paging message based on at least one of the one or more paging alerts. In some aspects, the base station can transmit the second paging message in the long duration, such as 10 seconds, after transmitting the first paging message. This can be because it can take a long time, such as 10 seconds, for the user to physically move the UE based on the one or more paging alerts. In some aspects, the first paging message and the second message can be similar or identical. For example, the first paging message and the second message can both indicate a same further communication, such as an incoming phone call. Thus, in case the UE misses the first paging message, the UE can still wake up to receive the further communication based on the second paging message. In other aspects, the first paging message and the second message can be different. For example, the first paging message can correspond to a first phone call and the second paging message can correspond to a second phone call.

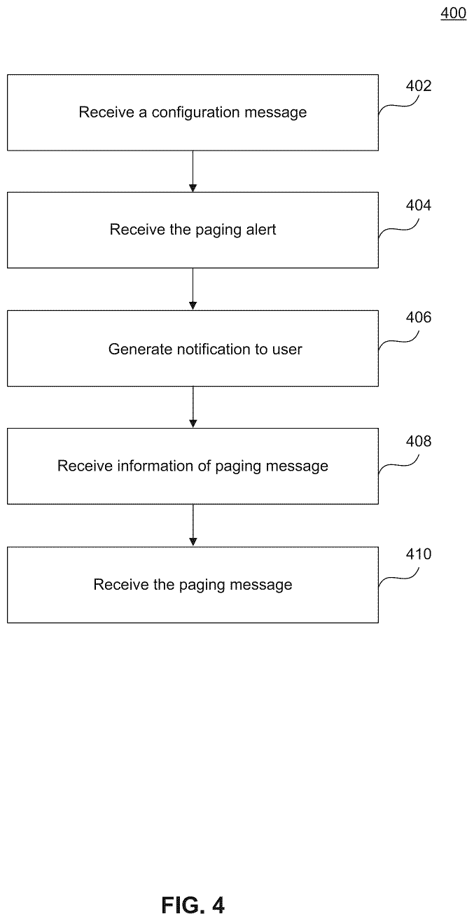

FIG. 4 illustrates an example method 400 of an example method of a UE operating based on a paging alert, according to aspects of the disclosure. The example method 400 is provided for the purpose of illustration only and does not limit the disclosed aspects. As a convenience and not a limitation, FIG. 4 may be described with regard to elements of FIGS. 1, 2, and 8. The example method 400 represents the operation of electronic devices (for example, the UE 102 of FIG. 1) implementing the paging alert operations. The example method 400 may also be performed by the electronic device 200 of FIG. 2, controlled or implemented by processor 210, and/or computer system 800 of FIG. 8. But the example method 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

At 402, the UE receives a configuration message from a base station, such as the base station 104 in FIG. 1. In some aspects, the configuration message is cell specific. Thus, UEs within a same cell, including the UE, share the same configuration message. In other aspects, the configuration message is UE specific. In either case, the configuration message can indicate a number of paging alert repetitions and a number of PDCCH signals repetitions. As discussed above in FIG. 3, the base station may repeatedly transmit the paging alert and/or the PDCCH signals to improve the chance that the UE receives the paging message during a subsequent transmission such as PDSCH signals. In some aspects, the paging alert repetitions can be in consecutive time slots or time slots separated by a constant interval. For example, the time slots separated by the constant interval can be in a control resource set #0 (CORESET #0) or a common CORESET in system information blocks 1 (SIB1). In some aspects, each of the paging alert repetitions includes a same content of the paging alert.

In some aspects, the configuration message can further indicate a first reference signal received power (RSRP) threshold for triggering the paging alert repetitions. For example, the UE can continuously monitor the RSRP of signals received from the base station, such as SSB signals. When the RSRP is lower than the first RSRP threshold, the UE can determine that the paging alert repetitions are needed so that the UE can successfully receive the paging alert. In such a case, the UE can report to the base station that the paging alert repetitions are needed and the base station can configure the UE with the paging alert repetitions. In addition, the UE can also determine whether the number of paging alert repetitions indicated by the configuration message is proper. For example, the RSRP may be so low that the UE may need at least X number of paging alert repetitions to successfully receive the paging alert, where X can be 20 for example. For another example, when the RSRP is within a range, the UE can determine that at least X number of paging alert repetitions are needed. The range can be between the first RSRP threshold and an RSRP lower bound that is lower than the first RSRP threshold. In this example, the configuration message may indicate 10 paging alert repetitions, which means that the base station will transmit the paging alert 10 times, not 20 times, repeatedly. In such a case, the UE can report to the base station to adjust the number of paging alert repetitions to 20. In some aspects, the UE can report the need of the paging alert repetitions and the number of paging alert repetitions via radio resource control (RRC) signaling and/or MAC Control Element (MAC CE) signaling.

In some aspects, the configuration message can further indicate a second RSRP threshold to trigger the UE to notify the user to physically move the UE. As discussed above, the UE may be placed in a pocket or a backpack so that signals from the base station are blocked. The paging alert may be transmitted using a higher power or a more robust modulation and coding schemes compared to other signals, such as the PDCCH signals 306 and the PDSCH signals 308 in FIG. 3. When the RSRP is below the second RSRP threshold, the UE may be able to receive the paging alert, but the UE is not able to receive the other signals. In such a case, the UE triggers a notification to the user to physically move the UE so that the RSRP can be improved and other signals can be received.

In some aspects, the configuration message can further indicate a time gap between the paging alert and PDCCH signals carrying information regarding the paging message, such as the period 312 in FIG. 3. In some aspects, the UE can determine whether the time gap indicated by the configuration message is proper. For example, the UE may determine that the RSRP is so low that the user likely needs at least 20 seconds to physically move the UE to a position where the RSRP is higher than the second RSRP threshold. However, the configuration message indicates that the time gap is 10 seconds. In such a case, the UE can report to the base station that a 20 seconds time gap is needed. In other words, the UE can report to the base station at a second time gap is needed that the longer than a first time gap that is preconfigured. The base station may adjust the time gap to 20 seconds. For another example, the UE can monitor user's behavior to determine the time gap as a user specific value. Specifically, the UE can record historical periods needed for a user to physically move the UE. For example, a first user may be vigilant and constantly pay attention to the UE, and its various notifications. Thus, the historical periods may be small because the first user likely can react to the notifications from the UE quickly. In such a case, the UE can determine the necessary time gap to be a small value. A second user may be easily distracted and thus does not pay close attention to the notifications from the UE or does not react promptly even after noticing a notification. Thus, the historical periods may be large. In such a case, the UE can determine the time gap needed to be a large value. In some aspects, the time gap can be a period between the paging alert and the paging message. In such a case, the time gap further includes a period of the PDCCH signals, such as the PDCCH signals 306.

In some aspects, the configuration message can indicate the time gap as a number of frames. For example, the configuration message can indicate that the time gap is 200 frames, which is 2 seconds. In some aspects, the configuration message can indicate the time gap by absolute time. For example, the configuration message can indicate that the time gap is 2 seconds. In some aspects, the configuration message can also indicate the time gap by an additional period on top of a predetermined maximum gap period of the PEI. For example, as discussed above, a time gap, such as the period 312 in FIG. 3, for the PEI has a maximum gap period of 16 frames or 160 ms. The time gap of the paging alert is larger than the maximum gap period. Thus, the configuration message can indicate the addition period on top of the maximum gap period. For example, the configuration message may indicate 500 ms. Thus, the time gap of the paging alert is 160 ms+500 ms =660 ms.

In some aspects, the time gap can be a predefined value instead of indicated by the configuration message. For example, the time gap can be predetermined to be 10 seconds. In some aspects, the time gap can be configured by signaling from the base station, such as the configuration message. For example, the base station can transmit the configuration message via cell-specific signals, such as SIB signals and RRC signals. For another example, the base station can transmit the configuration message via UE-specific signals, such as dedicated RRC signals and MAC CE signals. In some aspects, the base station can dynamically indicate the time gap. For example, the base station can configure one or more candidate time gaps via downlink signaling, such as the cell-specific signals including the SIB signals. Each of the one or more candidate time gaps can correspond to an index. In such a case, the paging alert can indicate a time gap by including or indicating an index of the time gap. For example, when the paging alert is in a new downlink control information (DCI) format, a DCI formal 2_7, or other DCI formats as discussed below, the paging alert can include the index in a payload. When the paging alert is a sequence as discussed above, the index can be a part of sequence generation initialization value. In either case, the UE can determine the time gap based on the index after extracting the index from the paging alert.

In some aspects, the number of paging alert repetitions can be predefined or configured, similar to the time gap as discussed above. For example, the number of paging alert repetitions can be a predefined value, such as 10 times. For another example, the number of paging alert repetitions can be configured via cell-specific signals, such as SIB signals and RRC signals, and/or via UE-specific signals, such as dedicated RRC signals and MAC CE signals. In some aspects, the UE can report its capability of receiving paging alert repetitions. For example, the UE may report whether it can monitor and receive paging alert repetitions. If the UE reports that the UE is not capable of receiving the paging alert repetitions, the base station may choose not to configure the paging alert repetitions for the UE. Otherwise, the base station can configure the paging alert repetitions for the UE.

In some aspects, the number of PDCCH signal repetition can be predefined or configured, similar to the time gap as discussed above. For example, the number of PDCCH signal repetition can be a predefined value, such as 10 times. For another example, the number of PDCCH signal repetition can be configured via cell-specific signals, such as SIB signals and RRC signals, and/or via UE-specific signals, such as dedicated RRC signals and MAC CE signals. In some aspects, the number of PDCCH signal repetition can be dynamically indicated. For example, the base station can pre-configure the UE with multiple possible repetition values. The base station can pre-configure the UE via SIB signals. In some aspects, each of the possible repetition values can correspond to an index. Thus, the base station can indicate to the UE a selected repetition value of the possible repetition values to use without having to include the selected repetition value itself in signaling. For example, the paging alert can include the index of the selected repetition value. In other aspects, the paging alert can include the selected repetition value itself in the payload of the paging alert. When the paging alert is a sequence, the base station can also generate the paging alert based on the selected repetition value as a part of sequence generation initialization value. In some aspects, the number of PDCCH signals can be implicitly indicated. For example, the number of PDCCH signals can be the same as the number of paging alert repetitions. For example, when the base station configures 10 paging alert repetitions, the UE can assume that 10 PDCCH signal repetition is also configured. For another example, the number of PDCCH signals repetition can correspond to the number of paging alert repetitions by a ratio. For example, the number of PDCCH signal repetition can be twice as many as the number of paging alert repetitions. In some aspects, the UE can be configured with a mapping table that indicates mapping rules between the number of PDCCH signal repetition and the number of paging alert repetitions. The UE can look up the number of PDCCH signal repetition using the mapping table based on the number of paging alert repetitions.

At 404, the UE receives the paging alert. The UE may receive the paging alert without the paging alert repetition or receive the paging alert in at least one of the paging alert repetitions. In some aspects, the paging alert can indicate the number of PDCCH signal repetitions in addition to the configuration message or instead of the configuration message. The paging alert can be in a new DCI format. For example, the paging alert may be UE specific. In some aspects, the paging alert may include at least a part of an ID of the UE. For example, the paging alert can include at least a part of a 5G-S-temporary mobile subscription identifier (5G-S-TMSI) of the UE. In some aspects, the paging alert may include a cyclic redundancy check (CRC) that is scrambled with at least a part of an ID of the UE. For example, the ID of the UE can be the 5G-S-TMSI or a new ID such as a paging alert radio network temporary identifier (PA-RNTI).

In some aspects, the paging alert may be in a DCI format 2_7. For example, the paging alert can be a group common DCI, where a group of UEs shares the paging alert. The UE can use an ID of the UE to obtain paging occasions and a sub-group of the UE based on the paging alert. In some aspects, the paging alert may also include a CRC that is scrambled using a paging early indication radio network temporary identifier (PEI-RNTI).

In some aspects, the paging alert may be a sequence based transmission. For example, an ID of the UE can be used to generate the sequence. Specifically, the sequence can be generated based on a modulo operation of the ID. In some aspects, the ID can include the 5G-S-TMSI.

At 406, the UE can generate a notification for the user of the UE. The notification can include a sound, a series of vibrations, or a text message. In some aspects, the UE generates the notification when the paging alert received in step 404 indicates the UE. For example, the paging alert may be in the new DCI format and the paging alert indicates an ID of the UE. For another example, the paging alert may be in a DCI format 2_7 that indicates a group of UEs and the group of UEs includes the UE. Specifically, the paging alert can include a bit corresponding to the group of UEs and the bit is set to 1. For yet another example, the paging alert may be a sequence that indicates the ID of the UE. In some aspects, when the paging alert indicates the UE, the UE further considers whether other conditions are met to notify the user. For example, the other conditions can include a RSRP measurement. Specifically, the UE can monitor and measure an RSRP of received signals, such as demodulation reference signal (DMRS) or SSB signals. If the RSRP is lower than a triggering threshold, similar to the second RSRP threshold discussed above, the UE can determine to trigger the notification to the user. In some aspects, the triggering threshold can correspond to an aggregation level of PDCCH. The aggregation level defines a granularity of PDCCH resource allocation. Specifically, one or more physical resource blocks (PRBs) are aggregated together as a control channel element (CCE) and assigned together. Thus, the aggregation level of PDCCH corresponds to a number of PRBs that are aggregated to be assigned together by the PDCCH. Here, the base station or the UE can determine that the larger the aggregation level, the higher the triggering threshold. The triggering threshold can be configured by the base station via signaling, such as the configuration message in 402. In some aspects, the other conditions can include an elevation angle of the UE in addition to the RSRP measurement or instead of the RSRP measurement. For example, the UE can measure and determine the elevation angle of the UE to the base station. If the elevation angle is smaller than a threshold angle, the UE can determine to trigger the notification to the user. This is because when the elevation angle is small, the path loss is large and the UE likely needs to be physically moved to a different location to properly receive the paging message. Similar to the triggering threshold, the threshold angle can also be configured by the base station via signaling, such as the configuration message in 402.

At 408, the UE receives information regarding the paging message. In some aspects, the UE receives the information via PDCCH signals, such as the PDCCH signals 306 in FIG. 3. In some aspects, the information includes a time location of the paging message within PDSCH signals, such as the PDSCH signals 308. The information can also include decoding configuration of the paging message, such as modulation configuration, coding configuration, and other configurations of the paging message, to enable the UE to decode the paging message.

At 410, the UE receives the paging message based on the information of the paging message. For example, the paging message may be included in PDSCH signals, such as the PDSCH signals 308 in FIG. 3. The UE can determine the time location of the paging message to receive the paging message and decode the paging message based on the decoding configuration including in the information of the paging message that is received via the PDCCH signals. In some aspects, the paging message indicates further communications from the base station, including phone calls and data transmissions. The UE can wake up based on the paging message to receive the further communications.

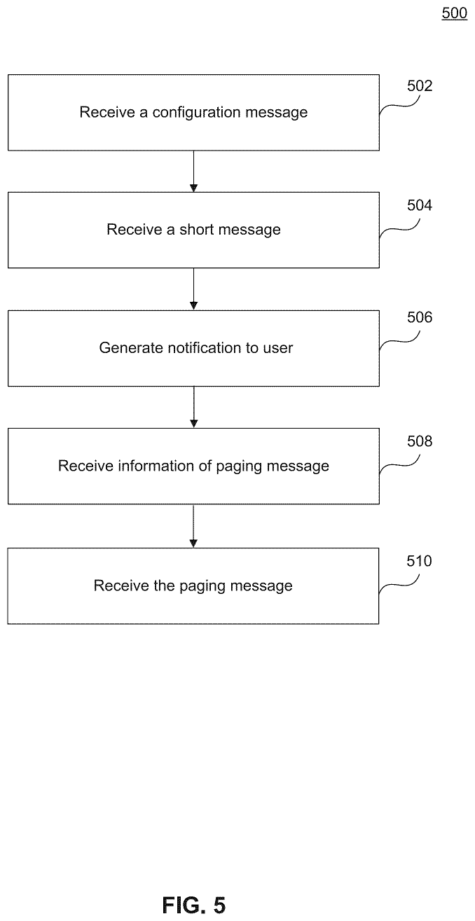

FIG. 5 illustrates an example method 500 of a UE operating based on a short message, according to aspects of the disclosure. In some aspects, the short message can be a part of a DCI signaling transmitted on a PDCCH. For example, the short message can be defined according to 3GPP TS 38.331 v. 17.2.0, section 6.5. The example method 500 is provided for the purpose of illustration only and does not limit the disclosed aspects. As a convenience and not a limitation, FIG. 5 may be described with regard to elements of FIGS. 1, 2, and 8. The example method 500 may represent the operation of electronic devices (for example, the UE 102 of FIG. 1) to receive the paging alert. The example method 500 may also be performed by the electronic device 200 of FIG. 2, controlled or implemented by processor 210, and/or computer system 800 of FIG. 8. But the example method 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

At 502, the UE receives a configuration message from a base station. In some aspects, the configuration message is similar to the configuration message discussed in 402 of FIG. 4. For example, the configuration message here can indicate a number of PDCCH signal repetitions. The configuration message can also indicate an RSRP threshold to trigger the UE to notify the user to physically move the UE. Furthermore, the configuration message can indicate a time gap between the short message and PDCCH signals carrying information regarding the paging message, such as the period 312 in FIG. 3. In some aspects, the UE can determine and report capability of receiving PDCCH signal repetitions and a desired number of PDCCH signal repetitions to the base station as similarly discussed regarding the capability of receiving paging alert repetitions and the number of paging alert repetitions in 402 of FIG. 4. For example, the UE can report to the base station that the UE is not capable of detecting and receiving the PDCCH signal repetitions. In such a case, the base station can refrain from configuring multiple PDCCH signal repetitions to the UE. For another example, the UE can report to the base station that the UE is capable of detecting and receiving the PDCCH signal repetitions and requires X number of PDCCH signal repetitions. In such a case, the base station can configure X number of PDCCH signal repetitions to the UE.

At 504, the UE receives a short message. In some aspects, the short message may include a CRC that is scrambled by an ID of the UE. For example, the ID of the UE can be a PA-RNTI of the UE. Thus, the UE can determine whether the short message indicates the UE. For example, if the UE determines that the CRC is scrambled by an ID of the UE, the UE can determine that the short message indicates the UE. Otherwise, the UE ignores the short message. Furthermore, the short message may include a bit that is used to indicate whether the short message acts as a paging alert. For example, the bit can be a fifth bit of the short message, or some other bit in the short message. Thus, when the UE determines that the short message indicates the UE and the short message acts as a paging alert, the UE determines that a paging message is to be received in upcoming signals.

At 506, the UE can generate a notification to a user of the UE. As discussed above in FIG. 4, the UE needs to receive and decode PDCCH signals, such as the PDCCH signals 306 in FIG. 3, and PDSCH signals, such as the PDSCH signals 308 in FIG. 3, to detect and receive the subsequent paging message. However, the UE may be placed in a pocket or a backpack that prevents the UE from detecting and receiving the PDCCH signals and the PDSCH signals. In such a case, when the UE determines that the paging message is to be received in upcoming signals, e.g., the PDCCH signals and PDSCH signals, the UE can generate a notification to the user to notify the user to physically move the UE. For example, the notification can cause the user to physically move the UE outside of the pocket or backpack. For another example, the notification can notify the user to physically move to a different location with a better signal reception. In some aspects, the UE can determine whether to generate the notification based further on an RSRP of received signals and/or an elevation angle to the base station as similarly discussed in 406 of FIG. 4.

At 508, the UE receives information regarding the paging message. In some aspects, the UE receives the information via PDCCH signals, such as the PDCCH signals 306 in FIG. 3. In some aspects, the information includes a time location of the paging message within PDSCH signals, such as the PDSCH signals 308. The information can also include decoding configuration of the paging message, such as modulation configuration, coding configuration, and other configurations of the paging message, to enable the UE to decode the paging message.

At 510, the UE receives and decodes the paging message based on the information of the paging message. For example, the paging message may be included in PDSCH signals, such as the PDSCH signals 308 in FIG. 3. The UE can determine the time location of the paging message to receive the paging message and decode the paging message based on the decoding configuration including in the information of the paging message. In some aspects, the paging message indicates further communications from the base station, including phone calls and data transmissions. The UE can wake up based on the paging message to receive the further communications.

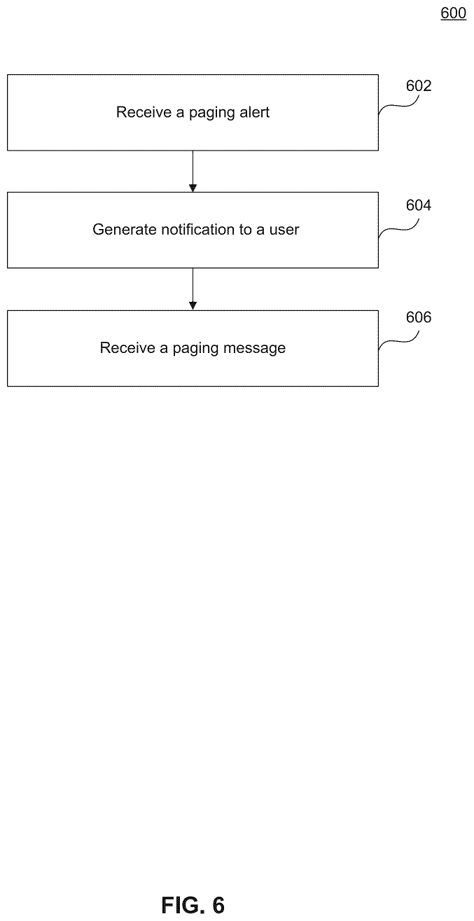

FIG. 6 illustrates an example method 600 of a UE operating using a paging alert, according to aspects of the disclosure. The example method 600 is provided for the purpose of illustration only and does not limit the disclosed aspects. As a convenience and not a limitation, FIG. 6 may be described with regard to elements of FIGS. 1, 2, and 8. The example method 600 may represent the operation of electronic devices (for example, the UE 102 of FIG. 1). The example method 600 may also be performed by the electronic device 200 of FIG. 2, controlled or implemented by processor 210, and/or computer system 800 of FIG. 8. But the example method 600 is not limited to the specific aspects depicted in those figures and other systems may be used to perform the method, as will be understood by those skilled in the art. It is to be appreciated that not all operations may be needed, and the operations may not be performed in the same order as shown in FIG. 6.

At 602, the UE receives a paging alert from a base station. In some aspects, the paging alert may indicate the UE. For example, the paging alert can include at least a part of an ID of the UE. For another example, the paging alert can include a CRC sequence, wherein the CRC sequence is scrambled based on at least a part of the ID of the UE. For yet another example, the paging alert can be generated based on the ID of the UE. In any of the above cases, the UE can determine that the paging alert indicates the UE.

At 604, the UE generates a notification to a user of the UE. In some aspects, the UE generates the notification when the UE determines that the paging alert indicates the UE as discussed above in 602. In addition, the UE may generate the notification based further on an RSRP of signals and/or an elevation angle. For example, when the UE determines that the RSRP of received signals from the base station is below a threshold value and/or that the elevation angle to the base station is smaller than a threshold angle, the UE can generate the notification for the user. In some aspects, the notification can notify the user of the UE to physically move the UE. For example, the notification can cause the user to physically move the UE outside of a pocket or a backpack. For another example, the notification can notify the user to physically move to a position with a better signal reception, such as a high ground with a LoS to a satellite connecting to the base station. In some aspects, the notification can be a sound notification to the user of the UE, a vibration notification to the user of the UE, and/or a text notification to the user of the UE.

At 604, the UE receives and decodes the paging message. As similarly discussed above in FIGS. 4 and 5, the UE can detect and receive information regarding the paging message in the PDCCH signals, such as the PDCCH signals 306 in FIG. 3. The information can include a time location of the paging message within PDSCH signals, such as the PDSCH signals 308. The information can also include decoding configurations of the paging message, such as modulation configuration, coding configuration, and other configurations of the paging message, to enable the UE to decode the paging message. The UE can then receive the paging message based on the information of the paging message. For example, the paging message may be included in PDSCH signals, such as the PDSCH signals 308 in FIG. 3. The UE can determine the time location of the paging message to receive the paging message and decode the paging message based on the decoding configuration including in the information of the paging message. In some aspects, the paging message indicates further communications from the base station, including phone calls and data transmissions. The UE can wake up based on the paging message to receive the further communications.

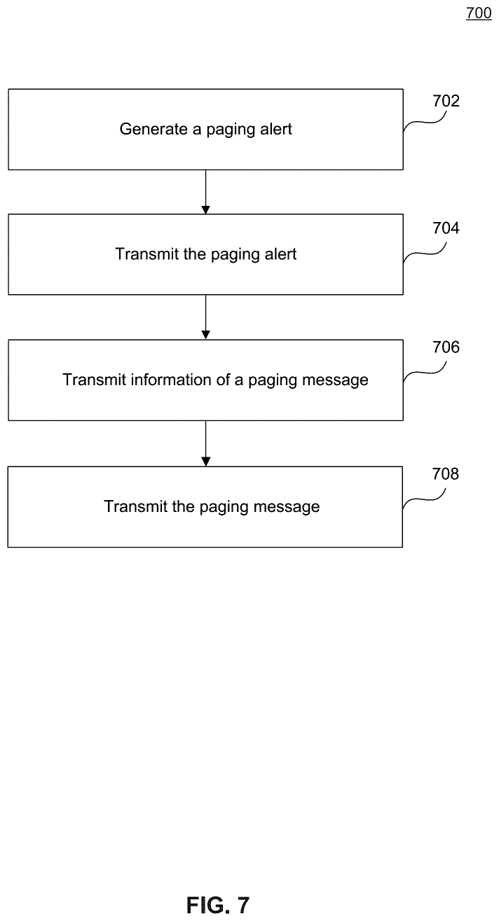

FIG. 7 illustrates an example method 700 of a base station operating using a paging alert, according to aspects of the disclosure. The example method 700 is provided for the purpose of illustration only and does not limit the disclosed aspects. As a convenience and not a limitation, FIG. 7 may be described with regard to elements of FIGS. 1, 2, and 8. The example method 700 may represent the operation of electronic devices (for example, the base station 104 of FIG. 1). The example method 700 may also be performed by the electronic device 200 of FIG. 2, controlled or implemented by processor 210, and/or computer system 800 of FIG. 8. But the example method 700 is not limited to the specific aspects depicted in those figures and other systems may be used to perform the method, as will be understood by those skilled in the art. It is to be appreciated that not all operations may be needed, and the operations may not be performed in the same order as shown in FIG. 7.

At 702, the base station generates a paging alert. The paging alert can indicate a UE served by the base station. For example, the paging alert can include at least a part of an ID of the UE. For another example, the paging alert can include a CRC sequence, wherein the CRC sequence is scrambled based on at least a part of the ID of the UE. For yet another example, the paging alert can be generated based on the ID of the UE. In any of the above cases, the UE can determine that the paging alert indicates the UE.

At 704, the base station transmits the paging alert to the UE. In some aspects, the base station can repeatedly transmit the paging alert for a number of times. In addition, the base station can transmit a configuration message to the UE. The configuration message can indicate the number of times of the paging alert repetitions. In some aspects, the base station can receive a report from the UE indicating whether the UE is capable of receiving the paging alert repetitions and/or a desired number of paging alert repetitions. When the report indicates that the UE is not capable of receiving the paging alert repetitions, the base station can transmit the paging alert once instead of multiple times. When the report indicates that the UE is capable of receiving the paging alert repetitions and request for a number of paging alert repetitions, the base station configures the UE with the number of paging alert repetitions using the configuration message and transmits the paging alert the number of times.

At 706, the base station can transmit information for a paging message in a PDCCH with PDCCH signals, such as the PDCCH signals 306 in FIG. 3, prior to transmitting the paging message. For example, the information can include a time location of the paging message within PDSCH signals, such as the PDSCH signals 308 in FIG. 3. The information can also include a decoding configuration for the paging message, such as modulation configuration, coding configuration, and other configurations of the paging message, to enable the UE to decode the paging message.

At 708, the base station transmits the paging message to the UE. In some aspects, the base station waits for a time period after transmitting the paging alert to transmit the paging message. The time period can be the time gap discussed in FIG. 4 and the period 312 in FIG. 3. The base station can transmit the paging message in the PDSCH with the PDSCH signals. After transmitting the information regarding the paging message in the PDCCH in step 706, the base station can subsequently transmit the PDSCH signals that include the paging message based on the information. In some aspects, the period, such as the time gap discussed in FIG. 4 and the period 312 in FIG. 3, can be a time difference between a first frame of the paging alert and a first frame of the PDCCH signals.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to some aspects, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

The operations in the preceding aspects may be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 800, main memory 608, secondary memory 810 and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 8. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
a transceiver configured to enable wireless communication with a base station; and
a processor communicatively coupled to the transceiver and configured to:
receive, using the transceiver, a paging alert (PA) from the base station,
generate a notification for a user of the UE to physically move the UE based on the PA; and
receive, using the transceiver, a paging message from the base station based on the PA.

2. The UE of claim 1, wherein the processor is further configured to:
receive a configuration message from the base station,
wherein the configuration message configures the UE to receive the PA and to generate the notification.

3. The UE of claim 2, wherein the configuration message indicates a number of repetition of the PA.

4. The UE of claim 2, wherein the configuration message indicates a time gap between the PA and the paging message.

5. The UE of claim 1, wherein to generate the notification, the processor is further configured to:
determine that a reference signal received power (RSRP) from the base station is lower than a threshold value; or
determine that an elevation angle to the base station is smaller than a threshold angle.

6. The UE of claim 1, wherein to generate the notification, the processor is further configured to:
determine that the paging alert includes at least a part of an identification (ID) of the UE;
determine that the paging alert includes a cyclic redundancy check (CRC) sequence, wherein the CRC sequence is scrambled based on at least a part of the ID of the UE; or
determine that the page alert is generated based on the ID of the UE.

7. The UE of claim 1, wherein to receive the paging message, the processor is further configured to:
receive a signal in a physical downlink control channel (PDCCH) based on the PA, wherein the signal indicates information of the paging message; and
receive the paging message in a physical data shared channel (PDSCH) based on the information.

8. The UE of claim 1, wherein the notification comprises:
a sound notification to the user of the UE,
a vibration notification to the user of the UE, or
a text notification to the user of the UE.

9. A method of operating a user equipment (UE) comprising:
receiving a paging alert (PA) from a base station,
generating a notification for a user of the UE to physically move the UE based on the PA; and
receiving a paging message from the base station based on the PA.

10. The method of claim 9, further comprising:
receiving a configuration message from the base station,
wherein the configuration message configures the UE to receive the PA and to generate the notification,
wherein the configuration message indicates a number of repetition of the PA, and
wherein the configuration message indicates a time gap between the PA and the paging message.

11. The method of claim 9, wherein generating the notification further comprises:
determining that a reference signal received power (RSRP) from the base station is lower than a threshold value; or
determining that an elevation angle to the base station is smaller than a threshold angle.

12. The method of claim 9, generating the notification further comprises:
determining that the paging alert includes at least a part of an identification (ID) of the UE;
determining that the paging alert includes a cyclic redundancy check (CRC) sequence, wherein the CRC sequence is scrambled based on at least a part of the ID of the UE; or
determining that the page alert is generated based on the ID of the UE.

13. The method of claim 9, wherein the notification comprises:
a sound notification to the user of the UE,
a vibration notification to the user of the UE, or
a text notification to the user of the UE.

14. A base station comprising:
a transceiver configured to enable wireless communication with a user equipment (UE); and
a processor communicatively coupled to the transceiver and configured to:
generate a paging alert (PA) that triggers the UE to generate a notification to physically move the UE;
transmit, using the transceiver, the PA to the UE; and
transmit, using the transceiver, a paging message based on the PA.

15. The base station of claim 14, wherein the processor is further configured to:
transmit a configuration message to the UE,
wherein the configuration message configures the UE to receive the PA and to generate the notification.

16. The base station of claim 15, wherein to transmit the PA, the processor is further configured to:
transmit the PA a first number of times repeatedly,
wherein the configuration message indicates the number.

17. The base station of claim 15, wherein the processor is further configured to:
transmit the paging message after a time period of transmitting the PA,
wherein the configuration message indicates the time period.

18. The base station of claim 14, wherein the PA is generated based on an ID of the UE, and includes:
at least a part of an identification (ID) of the UE; or
a cyclic redundancy check (CRC) sequence, wherein the CRC sequence is scrambled based on at least a part of the ID of the UE.

19. The base station of claim 14, wherein to transmit the paging message, the processor is further configured to:
transmit a signal in a physical downlink control channel (PDCCH) based on the PA, wherein the signal indicates information of the paging message; and
transmit the paging message in a physical data shared channel (PDSCH) based on the information.

20. The base station of claim 19, wherein to transmit the signal in the PDCCH, the processor is further configured to:
transmit the signal in the PDCCH a second number of times repeatedly,
wherein the configuration message indicates the second number.
